(19) United States
(12) Patent Application Publication
(10) Pub. No.: US 2013/0280392 A1
(43) Pub. Date: Oct. 24, 2013

(54) PROCESS FOR CONTROLLING MICROORGANISMS IN BEVERAGE PRODUCTS

(71) Applicant: Reed Semenza, Galt, CA (US)

(72) Inventor: Reed Semenza, Galt, CA (US)

(73) Assignee: DeLaval Holding AB, Tumba (SE)

(21) Appl. No.: 13/978,747

(22) PCT Filed: Jan. 16, 2012
(86) PCT No.: PCT/US2012/021427

§ 371 Date: Jul. 9, 2013

Related U.S. Application Data
(60) Provisional application No. 61/433,395, filed on Jan. 17, 2011.

(51) Int. Cl. A23L 2/44

(52) U.S. Cl. CPC A23L 2/44
USPC 426/330.5; 514/557; 424/616; 99/275

(57) ABSTRACT

Methods for reducing thermophilic spore-forming bacteria that can lead to off-odors and tastes in beverage products, especially fruit or vegetable juice products, are provided. The methods employ one or more peroxy acids that are added to the beverage handling system prior to pasteurization and concentration of the beverage product. Particularly, the peroxy acid is added prior to final filtration of the beverage product upstream of the pasteurizer and concentrator.

### BACKGROUND OF THE INVENTION

1. Field of the Invention

The present invention generally is directed toward methods of controlling bacteria, including spore formers, yeast, and fungal levels in beverage products by injecting a quantity of a peroxy acid into the beverage product. Particularly, the peroxy acid is a food-grade organic peroxy acid, such as peracetic acid, and is introduced into a beverage, such as a fruit or vegetable juice product, prior to pasteurization or concentration of the beverage. The peroxy acid especially is effective in reducing thermophilic bacteria which are capable of producing spores that can cause taste and odor problems in juice products.

2. Description of the Prior Art

Pasteurized juice has certain microbial specifications that must be met. While pasteurization eliminates most microorganisms present in the juice, it is not 100% efficacious against all microorganisms, particularly against thermophilic microorganisms. Certain spores and thermophilic bacteria can survive the evaporation and pasteurization processes only to grow when the juice concentrate is re-constituted resulting in taste and odor problems in the final product. Further, even if bacterial cells and spore levels are initially low, they tend to increase in number between the time the juice is filtered to the time it is concentrated and/or reconstituted.

Currently no method exists that would prevent thermophilic organisms from sporulating while the fruit or vegetable juice is being pasteurized or concentrated in an evaporator. Thus, the only method of avoiding the taste and odor problems caused by these microorganisms is to reject much of the raw fruit or vegetables that contain them. However, this is a costly and wasteful approach.

Additionally, any spores or microorganisms present prior to clarification of the juice product can clog the clarifying filter resulting in a decrease in filter efficacy.

### SUMMARY OF THE INVENTION

In one embodiment of the present invention, there is provided a process for controlling undesirable microbes in beverage products. The beverage product is derived from one or more fruits and/or vegetables, and in particular embodiments, comprises fruit or vegetable juice having a Brix content of at least 2.5. A peroxy acid, such as peracetic acid, is introduced into the beverage product in an amount that is effective to control thermophilic and other bacteria as well as final spore levels in the beverage without adversely impacting taste or color of the final product.

In another embodiment according to the present invention, there is provided a beverage processing system comprising a vessel containing a quantity of a beverage product derived from one or more fruits and/or vegetables and a peroxy acid injection station operable to introduce a quantity of a peroxy acid into the vessel containing the beverage product. The vessel can comprise any apparatus capable of containing a quantity of fluid including a tank or conduit through which the beverage product may flow. The processing system may also comprise a filtration device located downstream from the vessel operable to produce a clarified fruit and/or vegetable juice product.

### BRIEF DESCRIPTION OF THE DRAWINGS

FIG. 1 is a schematic diagram of a juice processing system in accordance with one embodiment of the present invention;

FIG. 2 is a schematic diagram of a juice reconstitution system in accordance with another embodiment of the present invention;

FIG. 3 is a photograph depicting the bleaching effect of increasing amounts of peracetic acid and hydrogen peroxide on cranberry juice color;

FIG. 4 is a graph showing the germicidal efficacy of peracetic acid against Alicyclobacillus acidoterrestris;

FIG. 5 is a graph showing the germicidal efficacy of peracetic acid versus chlorine dioxide in carrot and apple juice; and

FIGS. 6A and 6B are photographs depicting the immediate effect on juice color after addition of various concentrations of peracetic acid or chlorine dioxide at room temperature.

### DETAILED DESCRIPTION OF THE PREFERRED EMBODIMENT

In one embodiment of the present invention, a peroxy acid is employed to reduce the level of thermophilic bacteria and consequently the potential spore levels, bacteria, yeast, or mold present in beverage products, especially fruit and vegetable juices. In particular embodiments, the peroxy acid comprises an organic C1 to C18 peroxy acid such as peracetic acid (PAA) or peroctanoic acid. In other embodiments, the peroxy acid may be one component of a blend of acids. In such embodiments, in addition to the peroxy acid, the acid blend may include one or more members selected from the group consisting of C1 to C18 carboxylic acids and mineral acids, such as phosphoric, nitric, sulfuric or hydrochloric acid. Certain embodiments may also comprise the peroxy acid or acid blend in combination with other oxidizing compounds, such as hydrogen peroxide and peroxymonosulfate, and stabilizers. In particular embodiments, the peroxy acid employed is peracetic acid, which naturally exists in equilibrium with acetic acid and hydrogen peroxide as illustrated below.

CH₃CO₂—OH+H₂O₂+CH₃CO—OH→2CH₃CO—OH+O₂+H₂O

Exemplary peracetic acid solutions include Proxitane®, available from Solvay Chemicals, Inc., Delasan MP®, available from DeLaval Cleaning Solutions, and Tsunami®, available from Ecolab. The table below gives the compositional breakdown for several commercially available peracetic acid solutions.

| | | | | % Acetic | |
|---|---|---|---|---|---|
| Product | Supplier | % PAA | % H₂O₂ | Acid | Other |
| Peracetic | FMC | 5% | 22% | 10% | |
| Acid 5% | | | | | |
| Peracetic | FMC | 15% | 10% | 36% | |
| Acid 15% | | | | | |
| Delasan | DeLaval | 15% | 6% | 30-40% | |
| MP ® | | | | | |
| Peraclean | Evonic | 20-25% | 4-7% | 40-60 | |
| 22CW | | | | | |
| Proxitane ® | Solvay | 5% | 22% | NA | |
| Matrix ® | Ecolab | 3-7% | 5-10% | 15-40% | 3-7 |
| | | | | | peroctanoic; |
| | | | | | 1-5 caprylic |
| | | | | | acid |
| Premium | West | 5.6% | 26.5% | 7-8% | |
| Peroxide II | Agro, | | | | |
| | Inc. | | | | |

NA = information not available
Information taken from commercial literature or MSDS

The peroxy acid acts to reduce the level of bacteria, especially thermophilic bacteria, yeast, or mold present in the beverage product. Exemplary microorganisms upon which the peroxy acid acts include Alicyclobacillus acidoterrestris, Saccharomyces cerevisiae, Byssochlamys fulva, Salmonella, E. coli, Enterobacter, Shigella, Clostridium, Bacillus, Lactobacillus, Leuconostoc, Acetobacter, Candida, Pichia, Rhodotorula, Torulopsis, Zysossaccharomyces, Hansenula, Trichosporon, Paecilomyces, Aspergillus, Penicillum, and Neosartorya. In certain embodiments, addition of peroxy acid to beverage products during processing results in decreasing thermophilic bacterial levels to below 100 CFU/ml, or below 10 CFU/ml, or even below 1 CFU/ml.

Processes and systems described herein can be used in the production of fruit or vegetable juice products including those selected from the group consisting of orange juice, apple juice, grape juice, cherry juice, pear juice, peach juice, tomato juice, carrot juice, cranberry juice, grapefruit juice, pineapple juice, mango juice, pomegranate juice and combinations thereof. In other embodiments, the processes and systems described herein can be used in the production of juice drinks or juice beverages, wherein the juice is diluted with various amounts of water, sugar, dyes, vitamins, natural or artificial flavorings, nutritional additives, and opacifiers. In still other embodiments, the processes and systems described herein can be used with the production of beverage syrups, such as soda syrups. In particular embodiments, the beverage product has a Brix content of at least 2.5, or at least 5, or at least 10.

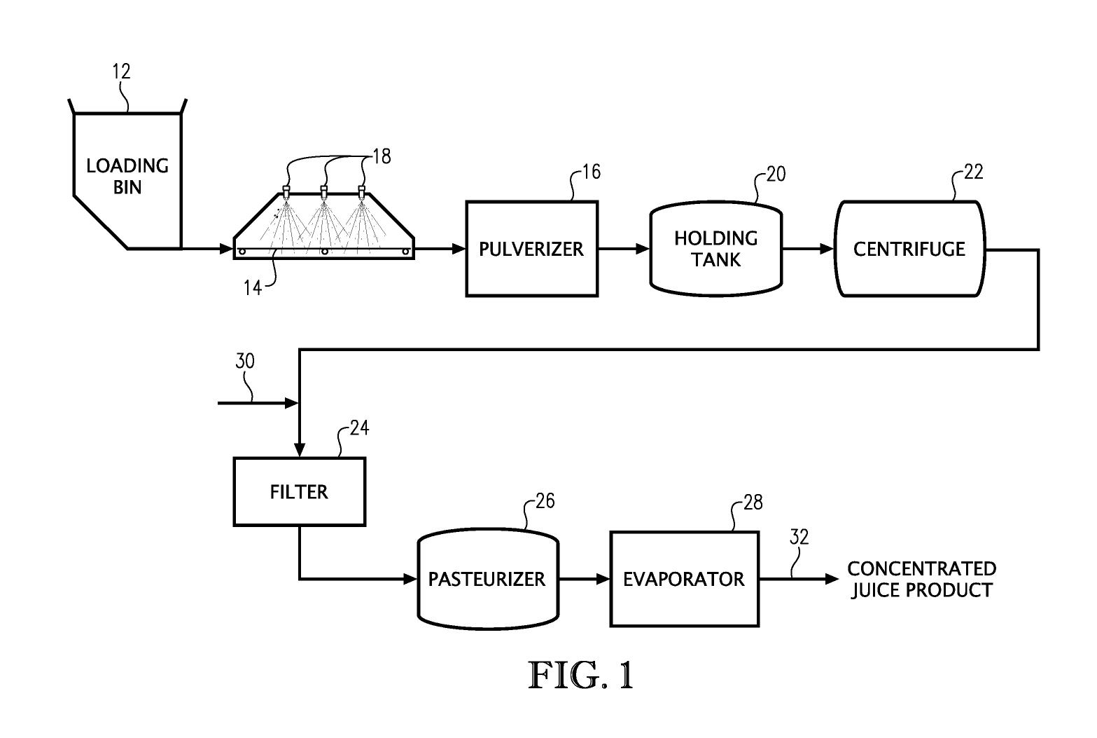

FIG. 1 illustrates a beverage processing system 10 according to one embodiment of the present invention. System 10 is particularly suited for processing of certain fruits or vegetables in the manufacture of a concentrated juice product. Particularly, system 10 may be employed in the manufacture of certain juices wherein the fruit or vegetable is pulverized, such as apple juice or carrot juice. However, it is within the scope of the present invention for the pulverizing equipment to be omitted when making other types of juice, like orange juice, where the juice is squeezed from the fruit without first undergoing pulverization. The changes in the basic set up from that shown in FIG. 1 for respective juice processing systems would be apparent to those of skill in the art.

Turning again to FIG. 1, fruit or vegetables are supplied from a loading bin 12 and transported on a conveyor 14 (e.g., a belt or screw conveyor) to a pulverizer 16. En route to pulverizer 16, the fruit or vegetables are washed by spray bars 18. A biocide, such as, but not limited to, peracetic acid, chlorine, hydrogen peroxide, acidified sodium chlorite, citric acid, or chlorine dioxide, may or may not be used during this wash process. In certain embodiments, about 20,000 gpd of water with or without biocide is used to treat the raw product, and the transport time from loading bin 12 to the pulverizer 16 is about 2.5 minutes.

The pulverized fruits or vegetables exiting pulverizer 16 are delivered to a holding tank 20, where the pulverized fruits or vegetables are permitted to macerate for maximum juice extraction. In certain embodiments, holding tank 20 is heated to 110° F. (43° C.) and the pulverized fruits or vegetables retained for about 45 minutes. The resulting fruit or vegetable slurry is then directed toward a centrifuge-type separator 22 where at least a portion of the solids in the juice slurry are separated from the juice. Next, the raw juice product is further clarified by removing various minute, suspended solids carried by the juice. In certain embodiments, this clarification is accomplished by passing the raw juice through a filtration device 24.

The permeate from the filter, or clarified juice, is sent to a pasteurizer 26 which heats the juice to 195° F. (90.5° C.) for 2 minutes. The pasteurized juice is then sent to an evaporator 28 where water is removed and the juice is concentrated for approximately 10 minutes. The temperature within evaporator 28 varies according to the juice and final brix content, but can be within the range of from about 165° F. (74° C.) to about 195° F. (90.5° C.).

In order to reduce or eliminate certain thermophilic bacteria or other microorganisms from the beverage product prior to pasteurization, filtration, or concentration, a quantity of a peroxy acid is introduced into the juice product at a point after the pulverizer 16, particularly just before the filter 24 or just after the centrifuge 22. In certain embodiments, all points of peroxy acid introduction are prior to passage of the juice through pasteurizer 26 or evaporator 28. In certain other embodiments, the peroxy acid may be injected after the evaporator 28 and any cooling apparatus (not shown) but prior to packaging. In the embodiment illustrated in FIG. 1, the peroxy acid is introduced to the raw juice at an injection station 30 downstream from centrifuge 22. It is, however, within the scope of the present invention for the peroxy acid to be introduced at other locations within system 10, such as upstream of centrifuge 22 or downstream from filtration device 24. In such alternate embodiments, the peroxy acid may be introduced into the fruit or vegetable slurry contained within or discharged from holding tank 20, or into the clarified juice product exiting filtration device 24, but prior to pasteurizer 28.

It is also within the scope of the present invention for the juice handling system to be configured without evaporator 28. In such an embodiment, the juice from pasteurizer 26 may be stored or immediately packaged. In another embodiment, the juice handling system may be configured without pasteurizer 26. In such an embodiment, the juice from filter 24 can be directly concentrated and then pasteurized upon reconstitution at a later time.

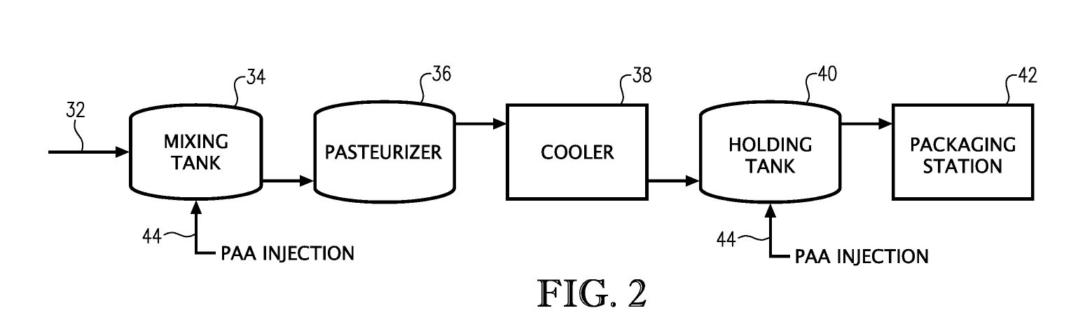

In still other embodiments, the peroxy acid can be added to a concentrated juice product after it has been reconstituted, but prior to pasteurization of the reconstituted juice. FIG. 2 illustrates an exemplary reconstitution process in which at least one concentrated juice 32, and optionally other juices or juice concentrates, is fed to a mixing tank 34 where it is diluted with water. After mixing, the reconstituted juice is delivered to a pasteurizer 36, then on to a cooler 38, holding tank 40, and packaging station 42. Peracetic acid 44 can be added to the reconstituted juice before pasteurization and/or after cooling but before packaging. In one embodiment, peracetic acid is added to mixing tank 34 during the reconstitution process. Alternatively, peracetic acid may be combined with the concentrated juice 32 prior to delivery to mixing tank 34. In another embodiment, peracetic acid 44 may be added to the reconstituted juice product contained in holding tank 40, or mixed in-line with the reconstituted juice delivered from cooler 38. In still other embodiments, peracetic acid 44 may be introduced into the juice product at both locations.

Irrespective of the precise location of peroxy acid injection, in certain embodiments it is desirable for the peroxy acid to be present within the beverage product for at least 10 minutes prior to final concentration or packaging, as the case may be. The heat associated with pasteurizer 26, 36 and evaporator 28 causes the peroxy acid to decompose so that it does not pass through into the finished beverage product, be it concentrated juice or reconstituted juice.

The half life of PAA decreases with increasing temperature. The half life of 100 ppm solution of PAA in carrot juice (Brix=8.8) at room temperature is less than 20 min. Similarly, the half life of a 100 ppm solution of PAA in apple juice (Brix=11.4) at room temperature is less than 30 min. After 10 min at 195° F. (90.5° C.), the PAA concentration of a 20 ppm solution of PAA in either carrot (Brix=8.8) or apple juice (Brix=11.4) is below the detectable limit of 0.89 ppm by titration with 0.1N sodium thiosulfate. Thus, when the juice is pasteurized and sent to an evaporator for concentration, any remaining PAA in solution would be converted to acetic acid, water, and oxygen, thereby leaving no or substantially no PAA remaining in the final juice product 32. Briefly, during the titration process, any oxidizing species present in the sample converts a solution of potassium iodide to iodine in the presence of ammonium paramolybdate and phosphoric acid. Subsequently, a starch solution is added to form a deep blue color upon binding iodine. The PAA concentration can be calculated based on the volume of titrant needed to revert the deep blue color.

In certain embodiments, the peroxy acid is introduced into the beverage product at a level of about 0.3 to about 100 ppm. In certain other embodiments, the peroxy acid is introduced into the beverage product at a level of between about 2 to about 20 ppm, and in still other embodiments, at a level of between about 5 to about 15 ppm.

In certain embodiments, the treatment described above results in very little or no color degradation in the beverage product. For instance, in such embodiments, a beverage product that has been treated with a peroxy acid exhibits a color intensity that is at least 70%, 80%, 90%, or 95% of the color intensity of the untreated beverage product. In a similar embodiment, the color intensity of the beverage product decreases by not more than 30%, 25%, 20%, 15%, 10%, or 5% subsequent to treatment with a peroxy acid. The color intensity of the untreated and treated beverage product is measured using a colorimeter, such as a spectrophotometer. In still further embodiments, the treatments described herein result in no color degradation of the beverage product that is perceptible to the human eye.

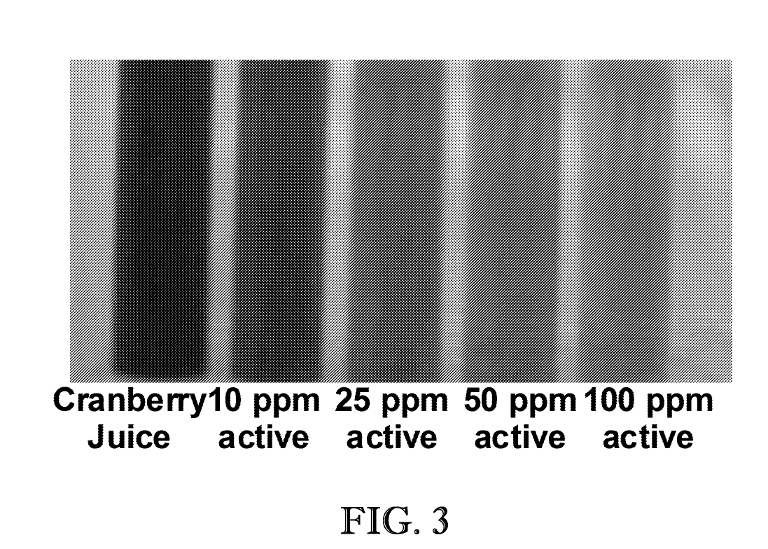

It has been observed that the rate of discoloration of the beverage product can be correlated with the amount of hydrogen peroxide in the peroxy acid solution. A bleaching effect has been observed in the beverage product when too much oxidizing compound is present in the peroxy acid solution, which causes the beverage product to undergo rapid discoloration. This bleaching effect occurs when the peroxy acid formula chosen has a high ratio of oxidizing compound to peroxy acid. Consequently, this abundance of oxidizing compound will effectively “bleach” and discolor the beverage product. An example of this bleaching effect in cranberry juice is shown in FIG. 3.

In order to address the potential bleaching effect, in certain embodiments of the invention is it preferable to employ a peroxy acid solution comprising a high concentration of peroxy acid (e.g., peracetic acid) and a low concentration of oxidizing compound (e.g., hydrogen peroxide). In such embodiments, the peroxy acid solution has a peroxy acid concentration of at least 10, 15, 18, or 20 weight percent and/or an oxidizing compound concentration of not more than 20, 15, 10, or 5 weight percent. Additionally or alternatively, the peroxy acid solution can have a weight ratio of at least 0.25, 0.5, 1, 1.5, 2, 3, 4, 5, or 6 parts peroxy acid per part oxidizing compound In other embodiments, the peroxy acid solution can have a weight ratio of peroxy acid to oxidizing compound of between about 1:6 to about 1:0.3, between about 1:3 to about 1:0.4, and between about 1:1 to about 1:0.66.

### EXAMPLES

The following examples set forth various trials performed with peracetic acid and chlorine dioxide, as a comparison. It is to be understood, however, that these examples are provided by way of illustration and nothing therein should be taken as a limitation upon the overall scope of the invention.

### Example 1

In this experiment, several juices were dosed with peracetic acid (PAA) (peroxyacetic acid 5.6%, hydrogen peroxide 26.5%) and kept at a controlled temperature (22° C. or 90° C.) for a given period of time to determine how the PAA would degrade over time. At the end of the given time period, the level of PAA remaining in the juice was measured by titration with 0.1N sodium thiosulfate. The results are listed in Table 1. It can be seen that the PAA decomposed quite rapidly in the various juices, particularly when exposed to elevated temperatures.

TABLE 1

| Juice¹ | Brix | PAA dosed | Temp | Time | PAA read |
|---|---|---|---|---|---|
| apple | 11.4 | 100 ppm | 22° C. | 60 min | 19.6 ppm |
| carrot | 8.8 | 100 ppm | 22° C. | 60 min | 3.92 ppm |
| apple* | 11.4 | 100 ppm | 90° C. | 10 min | 15.7 ppm |
| carrot* | 8.8 | 100 ppm | 90° C. | 10 min | 2.94 ppm |
| apple* | 11.4 | 20 ppm | 90° C. | 10 min | <0.98 ppm |
| carrot* | 8.8 | 20 ppm | 90° C. | 10 min | <0.98 ppm |

*followed by 5 min in ice to a final temperature of 20° C.
¹Commercially available, organic pasteurized ready-to-drink juice.

### Example 2

In this experiment, apple juice and carrot juice were exposed to pure and stable chlorine dioxide (CDG Solution 3000™, CDG Environmental, LLC) in order to determine their respective chlorine dioxide demands, as determined by HACH DPD Method for Chlorine dioxide (Method #10126). The juice samples were exposed to the chlorine dioxide under room temperature conditions (22° C.), and then the residual concentrations determined 10 minutes after exposure. The results of this experiment are shown in Table 2. It can be seen that the chlorine dioxide demands were relatively high.

TABLE 2

| | | Exposed Concentration | Read Concentration | Demand |
|---|---|---|---|---|
| Juice¹ | Brix | (ppm) | (ppm) | (ppm) |
| Apple | 11.4 | 5 | <0.05 | >4.95 |
| Apple | 11.4 | 10 | 0.68 | 9.32 |
| Apple | 11.4 | 25 | 0.7 | 24.3 |
| Apple | 11.4 | 60 | 2.2 | 57.8 |
| Carrot | 8.8 | 5 | <0.05 | >4.95 |
| Carrot | 8.8 | 10 | <0.05 | >9.95 |
| Carrot | 8.8 | 25 | <0.05 | >24.97 |
| Carrot | 8.8 | 60 | 0.13 | 59.87 |

¹Commercially available, organic pasteurized ready-to-drink juice.

### Example 3

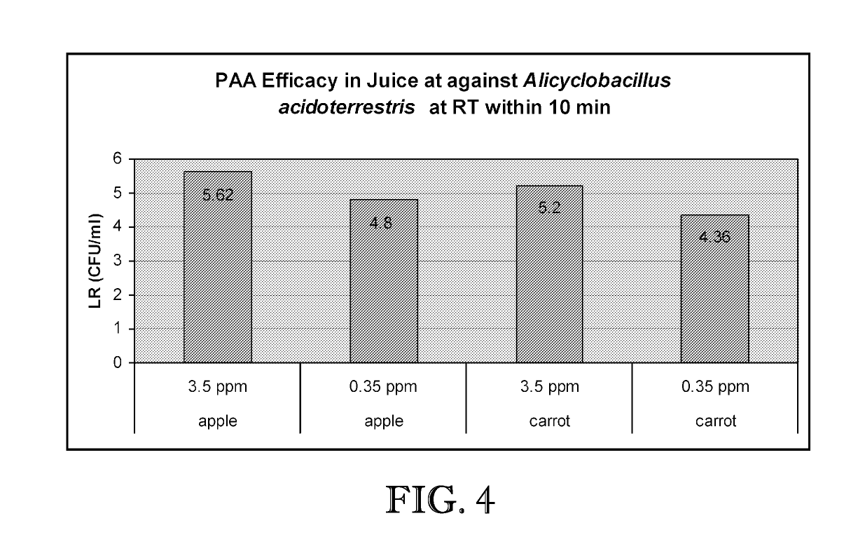

In this experiment, the antimicrobial efficacy of PAA in organic apple and carrot juice was measured by challenging the juices with 1×10⁷ CFU/ml of Alicyclobacillus acidoterrestris, a spore-forming thermophile commonly present in juice operations. Immediately following bacterial challenge, the juice was dosed with different concentrations of PAA and incubated at room temperature (22° C.) for 10 minutes without agitation. After the subscribed contact time, the PAA was neutralized with D/E broth and a viability count for each of the juices was performed using the most probable number technique (MPN). Overall, a PAA dose as low as 0.35 ppm was able to produce a substantial loss in cell viability. As can be seen in FIG. 4, the PAA-treated samples all exhibited greater than a 4-log reduction in the bacteria.

### Example 4

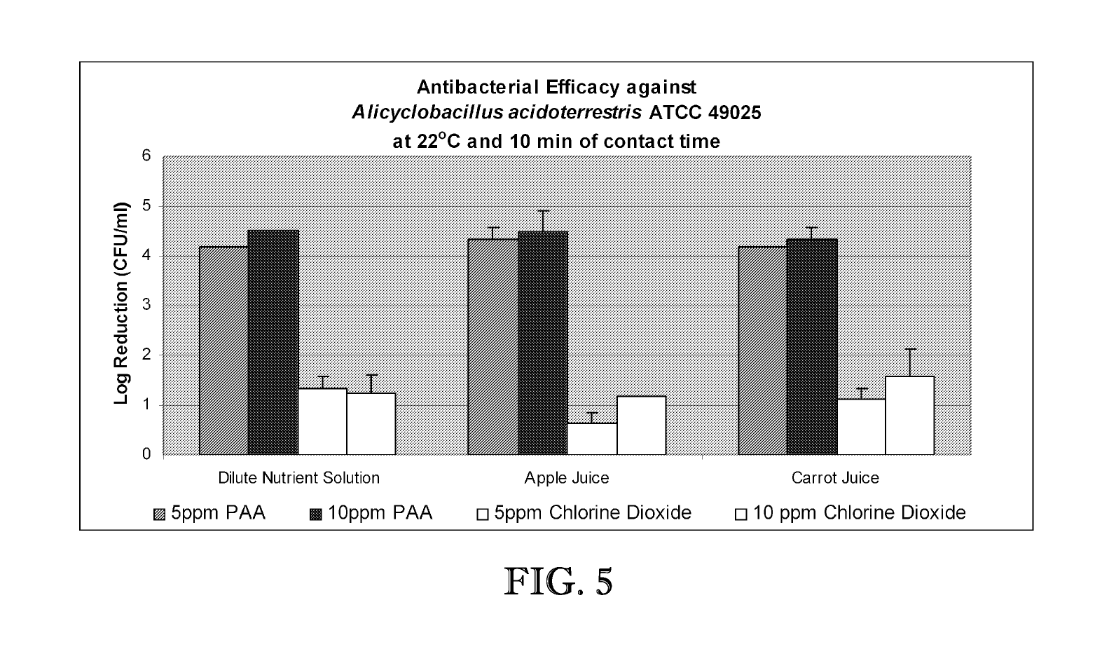

In this experiment, the germicidal efficacy of various concentrations of PAA and chlorine dioxide (by dilution of CDG Solution 3000™, CDG Environmental LLC) at 22° C. after 10 minutes of contact time was determined in a dilute nutrient solution (Tryptone pancreatic digest of casein 1.0 g/L and NaCl 8.5 g/L), apple juice, and carrot juice. Alicyclobacillus acidoterrestris ATCC 49025 was used as the inoculum at a concentration of 1.40×10⁷ CFU/ml. After the subscribed contact time, the PAA was neutralized with D/E broth and chlorine dioxide with a peroxide neutralizer, and a viability count for each of the juices was performed using the most probable number technique (MPN). The results are shown in Table 3, and graphically in FIG. 5.

TABLE 3

| Sample ID | Interfering Substance | LR | Std |
|---|---|---|---|
| 5 ppm PAA | Dilute nutrient solution | 4.18 | 0 |
| 10 ppm PAA | Dilute nutrient solution | 4.51 | 0 |
| 5 ppm chlorine dioxide | Dilute nutrient solution | 1.34 | 0.24 |
| 10 ppm chlorine dioxide | Dilute nutrient solution | 1.24 | 0.38 |
| 5 ppm PAA | Apple Juice¹ | 4.34 | 0.24 |
| 10 ppm PAA | Apple Juice¹ | 4.48 | 0.43 |
| 5 ppm chlorine dioxide | Apple Juice¹ | 0.65 | 0.19 |
| 10 ppm chlorine dioxide | Apple Juice¹ | 1.18 | 0 |
| 5 ppm PAA | Carrot Juice¹ | 4.18 | 0 |
| 10 ppm PAA | Carrot Juice¹ | 4.34 | 0.24 |
| 5 ppm chlorine dioxide | Carrot Juice¹ | 1.12 | 0.21 |
| 10 ppm chlorine dioxide | Carrot Juice¹ | 1.57 | 0.56 |

*chlorine dioxide: by dilution of CDG 3000 ™ an aqueous solution of 3000 ppm chlorine dioxide
¹Commercially available, organic pasteurized ready-to-drink juice.

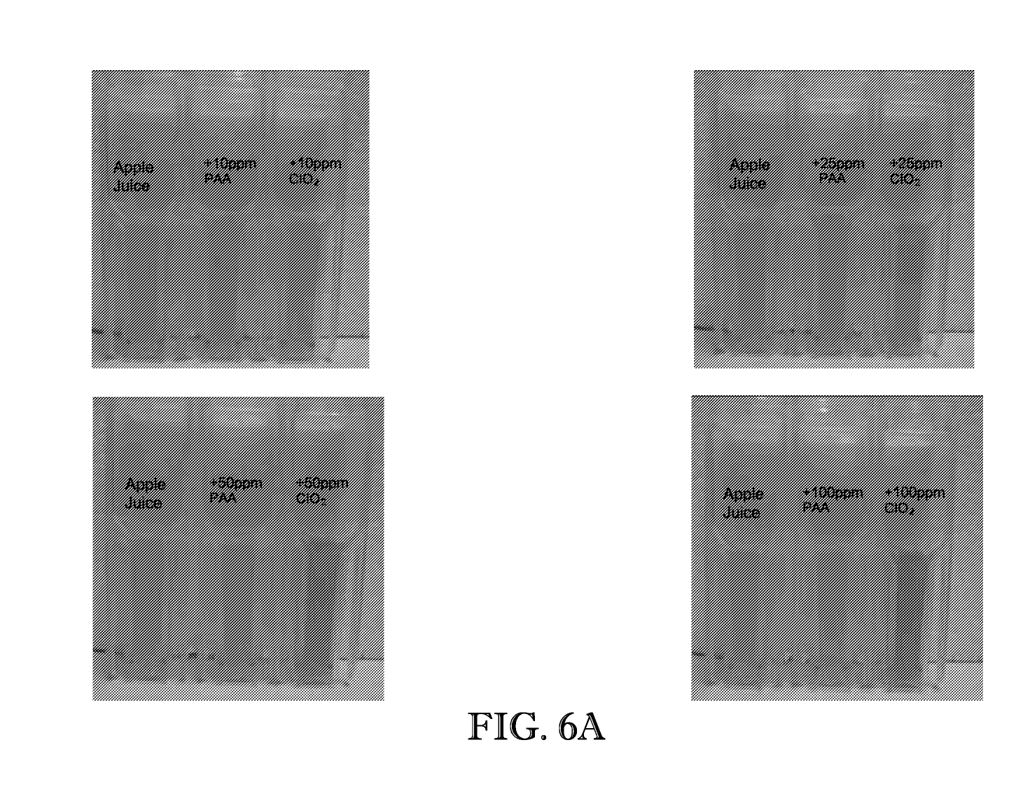

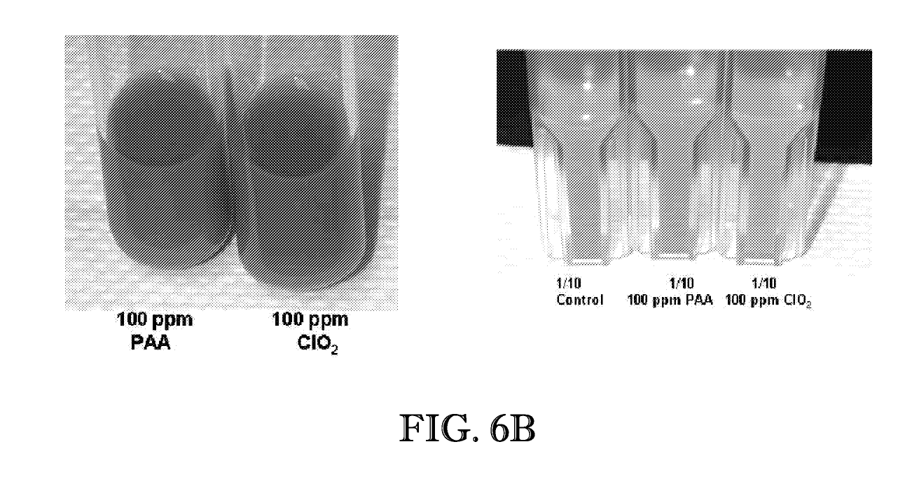

As can be seen, the PAA-treated samples all exhibited greater than a 4-log reduction in the bacteria. Conversely, the chlorine dioxide-treated samples exhibited only about a 1-log reduction in the bacteria. In addition, immediate discoloration of apple juice was observed upon addition of chlorine dioxide (FIG. 6A). Carrot juice discoloration was observed within 24 hours of treatment with chlorine dioxide (FIG. 6B).

### Example 5

In this experiment, the effect of PAA or chlorine dioxide addition on juice color was evaluated. Commercially available, organic pasteurized ready-to-drink apple and carrot juices were exposed to 10, 25, 50, or 100 ppm of either PAA or chlorine dioxide (CDG Solution 3000™, CDG Environmental LLC) at room temperature (ca. 22° C.). Color integrity was determined by comparison with untreated juice (FIGS. 6A and 6B). A change in color in carrot juice was observed after addition of 100 ppm of chlorine dioxide. The change in color is more evident when the exposed samples are diluted 10×. A change in color in apple juice was observed after addition of 25 ppm of chlorine dioxide. Addition of PAA to up to 100 ppm did not have a detectable effect on the color of either carrot or apple juice.

1. A process for controlling undesirable microbes in beverage products comprising:
providing a beverage product derived from one or more fruits or vegetables; and
introducing a quantity of a peroxy acid into said beverage product.

2. The process according to claim 1, wherein said beverage product is a fruit or vegetable juice product.

3. The process according to claim 2, wherein said fruit or vegetable juice product is selected from a member of the group consisting of orange juice, apple juice, grape juice, cherry juice, pear juice, peach juice, tomato juice, carrot juice, cranberry juice, grapefruit juice, pineapple juice, and combinations thereof.

4. The process according to claim 2, said process further comprising forming said juice product by squeezing or pulverizing raw fruits or vegetables into a fruit or vegetable slurry.

5. The process according to claim 4, said process further comprising removing solids suspended in said fruit or vegetable slurry.

6. The process according to claim 5, wherein said solids removing step is performed using a clarifying filter.

7. The process according to claim 6, wherein said peroxy acid is added to said fruit or vegetable slurry prior to passage through said clarifying filter.

8. The process according to claim 6, wherein the permeate from said clarifying filter is pasteurized and subsequently concentrated.

9. The process according to claim 1, wherein said peroxy acid comprises peracetic acid.

10. The process according to claim 9, wherein said peroxy acid comprises hydrogen peroxide, wherein said peroxy acid comprises a weight ratio of said peracetic acid to said hydrogen peroxide of at least 0.25:1.

11. The process according to claim 1, wherein said peroxy acid is introduced into said beverage product at a level of between about 0.3 to about 100 ppm.

12. The process according to claim 1, wherein said peroxy acid is introduced into said beverage product in sufficient quantity to reduce the concentration of thermophilic bacteria in said beverage product to below 100 cfu/ml.

13. The process according to claim 1, wherein said beverage product is a concentrated juice product.

14. The process according to claim 13, wherein said process includes reconstituting said concentrated juice product by adding water thereto and thereby forming a reconstituted juice product.

15. The process according to claim 14, wherein said peroxy acid is added to said concentrated juice product prior to or during reconstitution thereof.

16. The process according to claim 14, wherein said reconstituted juice product is pasteurized thereby forming a pasteurized juice product.

17. The process according to claim 16, wherein said peroxy acid is added to said reconstituted juice product prior to pasteurization thereof.

18. The process according to claim 16, wherein said pasteurized juice is cooled, and said peroxy acid is added to said cooled pasteurized juice prior to being packaged.

19. A beverage processing system comprising:
a vessel containing a quantity of a beverage product derived from one or more fruits or vegetables; and
a peroxy acid injection station operable to introduce a quantity of a peroxy acid into said vessel containing said beverage product.

20. The system according to claim 19, said system further comprising a filtration device located downstream from said vessel operable to produce a clarified fruit and/or vegetable juice product.

21. The system according to claim 20, wherein said peroxy acid injection station is located upstream from said filtration device.

22. The system according to claim 19, wherein said peroxy acid injection station is operable to deliver said peroxy acid to the beverage product in said vessel at a concentration of between about 0.3 to about 20 ppm.

23. The system according to claim 19, wherein said peroxy acid injection station is operable to deliver said peroxy acid to the beverage product in said vessel in sufficient quantity to reduce the concentration of acidophilic, thermophilic bacteria present in the beverage product to below 100 cfu/ml.

24. The system according to claim 19, wherein said peroxy acid introduced into the beverage product at said injection station comprises peracetic acid.

25. The system according to claim 20, said system further comprising a pasteurization vessel located downstream from said filtration device.

26. The system according to claim 20, said system further comprising an evaporator located downstream from said filtration device.

27. The system according to claim 19, wherein said system comprises a pasteurizer located downstream from said vessel.

28. The system according to claim 27, wherein said vessel comprises a mixing tank into which a supply of water is directed for mixing with said beverage product.

29. The system according to claim 27, wherein said system further comprises a cooler located downstream from said pasteurizer operable to reduce the temperature of juice product delivered from said pasteurizer.

30. The system according to claim 29, wherein said peroxy acid injection station is located downstream from said cooler.

31. The system according to claim 30, wherein said vessel comprises a holding tank located downstream from said cooler and upstream from a packaging station.
